(19) United States
(12) Patent Application Publication
(10) Pub. No.: US 2009/0137136 A1
(43) Pub. Date: May 28, 2009

(54) Housing, Terminal and Connector Using Housing and Terminal

(76) Inventor: Leif Shen, Chingli Tayuan (TW)

Correspondence Address: HARRINGTON & SMITH, PC, 4 RESEARCH DRIVE, Suite 202, SHELTON, CT, 06484-6212, US

(21) Appl. No.: 11/922,800

(22) PCT Filed: Jun. 27, 2006
(86) PCT No.: PCT/SG2006/000175

§ 371 Date: Dec. 21, 2007

(30) Foreign Application Priority Data
Jun. 27, 2005 (TW) 094121508

(51) Int. Cl. H01R 12/00; H01R 13/40; H01R 13/635

(52) U.S. Cl. 439/83; 439/733.1; 439/607.22

(57) ABSTRACT

A connector for connecting a card to a printed circuit board is provided. The connector includes a housing Z and a plurality of terminals. The housing includes a plurality of slots and at least one trench disposed in the vicinity of each of the plurality of slots. Each of the plurality of terminals includes a contact portion to be in contact with the card, an anchoring portion, four feet extending vertically from the anchoring portion, and a soldering portion extending from the anchoring portion and to be soldered to the printed circuit board. The terminal is mounted on the housing with at least one of the feet of the terminal inserted in at least one trench. The soldering portion is offset from the contact portion so that the contact portion will not come into contact with the soldering portion (when the contact portion is pressed towards the soldering portion, thereby providing a low-profile connector.

### BACKGROUND OF THE INVENTION

1. Field of the Invention

The present invention relates to a terminal, a housing of a card connector and a card connector using the terminal and the housing. The special application of the present invention is a connector adhered to a printed circuit board, for example, the connector designed for surface mounting, for providing an electronic connection between a microcircuit intelligent card and a microcircuit electronic system. The electronic system is, for example, an intelligent card reader or a mobile phone.

2. Description of the Prior Art

In the development of information science and technology, a mobile phone and other personal communication equipment have been more and more widely used. The present invention is a connector with feet soldered to a printed circuit board, and it is designed for use with surface mounting techniques, so as to achieve the objective of reducing the whole volume and area. One end of each of the feet is flattened, so as to have a contact surface with the printed circuit board. Each foot to be soldered defines a contact surface to be in contact with the printed circuit board. A relevant invention is US Patent Publication No. 2001/0034162A1. The US application discloses an invention having an insulating structure and a plurality of elastic conducting elongated strips. Each elongated strip has a first higher end point portion and a second lower end point, so as to form a shape of a contact foot, and each elongated strip is arranged in the insulating structure. Each contact foot is suitably soldered to the surface of a printed circuit board, and each contact foot is vertically pre-stressed to lower the profile of the foot. Therefore, each soldered contact foot is at the same level. As for the level, the present invention provides a further improvement.

### SUMMARY OF THE INVENTION

The present invention relates to a card connector, and more particularly to a SIM card connector for receiving the SIM card. This kind of connector is mostly needed by portable devices, so space is an important factor, and how to effectively reduce the space without impairing the function becomes an important issue. According to the present invention, a housing has a plurality of completely hollowed slots, on which a plurality of terminals is easily mounted. Moreover, the plurality of terminals mounted in the slots has a higher end point portion used to be in contact with the card and a lower end point portion used to be soldered to the printed circuit board. The higher end point of each terminal is designed to be offset from the lower end point, so as to effectively lower the profile of the connector. Therefore, in the present invention, under the condition of maintaining the contacting effect, the function of effectively lowering the profile of the SIM card connector is achieved. In order to achieve the above function, the connector of the present invention comprises a housing (2) including a plurality of slots (41, 42, 43, 44, 45, 46) and at least one trench disposed in the vicinity of each of the plurality of slots (41, 42, 43, 44, 45, 46); and a plurality of terminals (3). The terminal (3) used in the connector comprises a contact portion (31) to be in contact with the card, an anchoring portion (32) adjacent to the contact portion, and a soldering portion (39) extending from the anchoring portion (32) and to be soldered to the printed circuit board. The terminal (3) is mounted by inserting at least one foot of the terminal into at least one trench, and thus the terminal (3) is easily mounted on the housing (2). Moreover, the soldering portion (39) of the terminal is designed to be offset from the center line of the contact portion (31), such that the contact portion (31) will not come into contact with the soldering portion (39) when the contact portion (31) is pressed towards the soldering portion (39), thereby increasing the flexibility in utilizing space.

### BRIEF DESCRIPTION OF THE DRAWINGS

FIG. 1 is a bottom perspective view of a preferred embodiment of the connector according to the present invention.

FIG. 2 is a front perspective view of a preferred embodiment of the connector according to the present invention.

FIG. 3 is a bottom perspective view of a preferred embodiment of the housing according to the present invention.

FIG. 4 is a perspective view of a preferred embodiment of the terminal according to the present invention.

### DETAILED DESCRIPTION

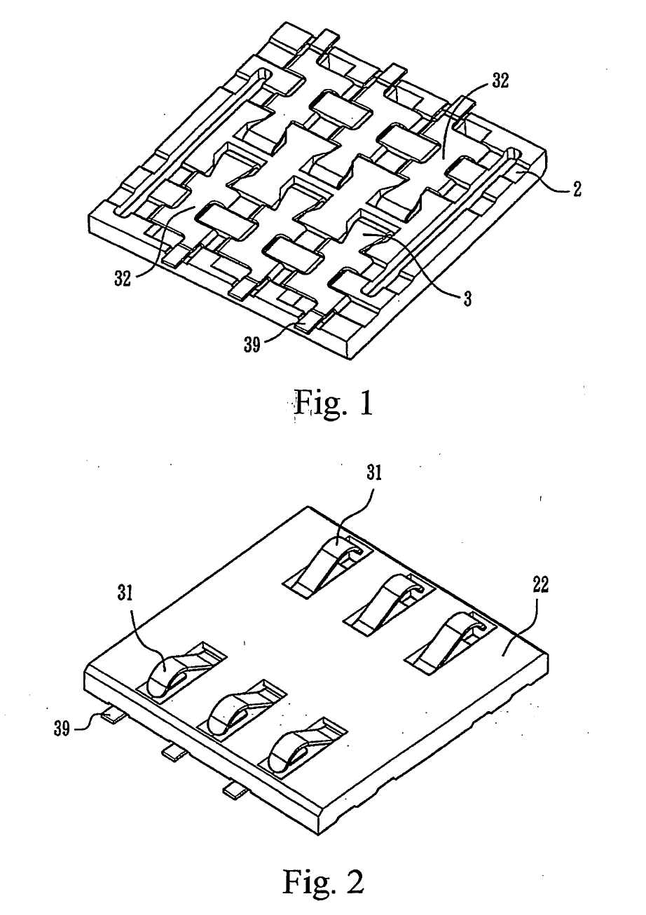

A connector for connecting a card to a printed circuit board as shown in FIG. 1 and FIG. 2 comprises a housing (2) and a terminal (3). The terminal has a contact portion (31), an anchoring portion (32) and a soldering portion (39).

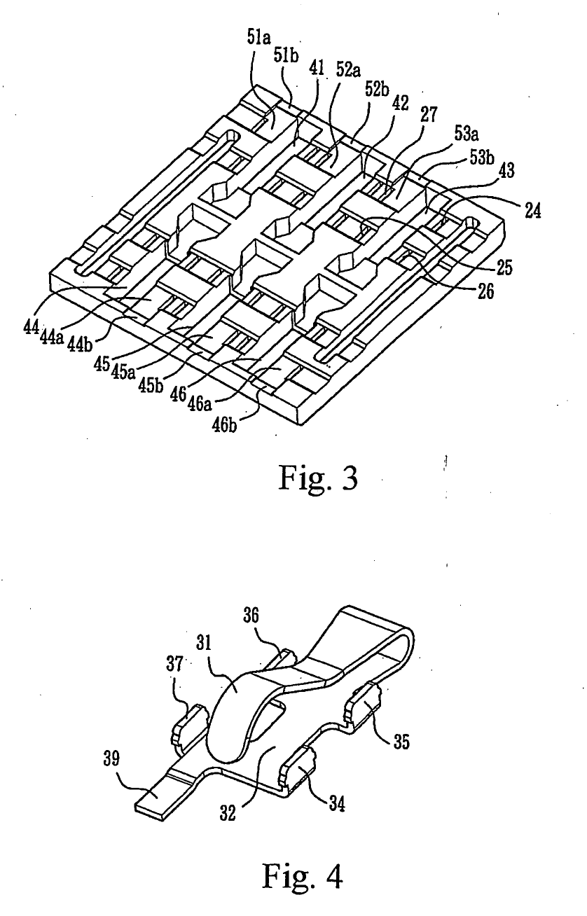

A housing (2) for accommodating a plurality of terminals is shown in FIG. 3. The housing (2) comprises a plurality of slots (41, 42, 43, 44, 45, 46) respectively used to accommodate the plurality of terminals (3), and four trenches (24, 25, 26, 27) disposed in the vicinity of each of the plurality of slots (41, 42, 43, 44, 45, 46) to receive feet (34, 35, 36, 37) of each of the plurality of terminals, so as to achieve the function of mounting the terminal (3). A fourth trench (27) of the four trenches (24, 25, 26, 27) is disposed farther than the first, second and third trenches (24, 25, 26) from a corresponding slot. The four trenches (24, 25, 26, 27) for one terminal (3) are formed within a first recess (44a, 45a, 46a, 51a, 52a, 53a) at a first level. The housing comprises a second recess (44b, 45b, 46b, 51b, 52b, 53b) at a second level.

FIG. 4 shows a terminal (3). The terminal (3) comprises a contact portion (31), an anchoring portion (32) adjacent to the contact portion (31), four feet (34, 35, 36, 37) vertically extending from the anchoring portion, and a soldering portion (39). As described above, the anchoring portion (32) is adjacent to the contact portion (31), and the two portions (31, 32) form a U shape. Moreover, the soldering portion (39) extends from the contact portion (31) and is offset from the center line of the contact portion (31), such that the contact portion (31) will not come into contact with the soldering portion (39) when the contact portion (31) is pressed towards the soldering portion (39), thus achieving the objective of reducing the level.

FIG. 1 also shows a view of an optimum mounting manner. The four feet (34, 35, 36, 37) of the plurality of terminals (3) are respectively inserted into the four trenches (24, 25, 26, 27), so as to be mounted on the housing (2). The soldering portion (39) is offset from the center line of the contact portion (31), such that the contact portion (31) will not come into contact with the soldering portion (39) when the contact portion (31) is pressed towards the soldering portion (39), thus achieving the objective of reducing the level. Therefore, as shown in FIG. 3, a fourth trench (27) of the four trenches (24, 25, 26, 27) is disposed farther than the first, second and third trenches (24, 25, 26), and that is because the soldering portion must be offset to a side, and the position of the fourth trench (27) is farther than that of the other three trenches. As shown in FIG. 3, the four trenches (24, 25, 26, 27) used by each terminal (3) may be formed on a first recess (44a, 45a, 46a, 51a, 52a, 53a) at a first level, which is the position of the anchoring portion (32). The connector of the present invention further comprises a second recess (44b, 45b, 46b, 51b, 52b, 53b) at a second level, which is the position of the soldering portion (39). Therefore, the anchoring portion (32) is located at a different level from the soldering portion (39).

1. An electrical connector housing for accommodating a plurality of terminals having a contact portion, an anchoring portion, and at least one foot extending from the anchoring portion the housing, comprising:
a plurality of slots each for receiving one of the plurality of terminals; and
at least one trench disposed in the vicinity of each of the plurality of slots, wherein at least one foot of each of the plurality of terminals is inserted in at least one trench.

2. The housing (2) as claimed in claim 1, wherein the number of the at least one trench is four trenches.

3. The housing as claimed in claim 2, wherein a fourth trench is disposed farther than a first, second and third trench from a corresponding slot.

4. The housing as claimed in claim 2, wherein the four trenches for one terminal are formed within a first recess at a first level.

5. The housing as claimed in claim 2, further comprising a second recess at a second level.

6. A terminal for use in an electrical connector, comprising: a contact portion;
an anchoring portion (adjacent to the contact portion;
at least one foot extending vertically from the anchoring portion; and
a soldering portion R extending from the contact portion and being offset from the contact portion so that the contact portion will not come into contact with the soldering portion when the contact portion is pressed towards the soldering portion.

7. The terminal as claimed in claim 6, wherein the number of the at least one foot is four.

8. The terminal as claimed in claim 6, wherein the anchoring portion and the contact portion form a U shape.

9. An electrical connector M for connecting a card to a printed circuit board, comprising:
a housing, including:
a plurality of slots, and at least one trench disposed in the vicinity of each of the plurality of slots; and
a plurality of terminals, each having a contact portion to be in contact with the card, an anchoring portion adjacent to the contact portion, with at least one foot extending vertically from the anchoring portion, and a soldering portion extending from the anchoring portion and to be soldered to the printed circuit board,
wherein the terminal is mounted on the housing with at least one foot inserted in at least one trench of the housing;
wherein the soldering portion is offset from the contact portion such that the contact portion will not come into contact with the soldering portion when the contact portion is pressed towards the soldering portion.

10. The connector as claimed in claim 9, wherein the at least one trench is four trenches.

11. The connector as claimed in claim 10, wherein a fourth trench is disposed farther than a first trench, a second trench and a third trench.

12. The connector as claimed in claim 10, wherein the four trenches for one terminal are formed within a first recess at a first level.

13. The connector as claimed in claim 12, wherein the housing further comprises a second recess at a second level.

14. The connector as claimed in claim 12, wherein the anchoring portion is at a different level from the soldering portion.

15. The connector as claimed in claim 9, wherein the at least one foot is four feet.
